(19) United States
(12) Patent Application Publication
(10) Pub. No.: US 2024/0013601 A1
(43) Pub. Date: Jan. 11, 2024

(54) Smart Access Control System for Infection and Safety Control

(71) Applicant: Ahmad SALEH, Motor City, Dubai (AE)

(72) Inventor: Ahmad SALEH, Motor City, Dubai (AE)

(21) Appl. No.: 18/018,777

(22) PCT Filed: Jul. 29, 2021
(86) PCT No.: PCT/IB2021/056915

§ 371 Date: Jan. 30, 2023

Related U.S. Application Data
(60) Provisional application No. 63/134,294, filed on Jan. 6, 2021.
(60) Provisional application No. 63/058,614, filed on Jul. 30, 2020.

(51) Int. Cl. G07C 9/38

(52) U.S. Cl. CPC G07C 9/38

(57) ABSTRACT

There is provided a smart access control system (SACS) for controlling access to a controlled zone for safety or infection control, the system comprising a Smart Access Control Unit (SACU) configured/adapted to be coupled to a user device (UD) for use by a user as a status and condition, among other health and safety conditions, to being granted access to the controlled zone, and a Smart Access Control Device (SACD) configured/adapted to be in wireless communication with the SACU for controlling access of the user to the controlled zone based on the compliance of the user with health and safety requirements including the proper use of the PPE.

### FIELD OF THE INVENTION

The present invention relates to access control systems, and more particularly to a smart access control system for infection control against infectious diseases (such as COVID-19), and a related smart access control unit for use with a Personal Protective Equipment and a related method.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

The COVID-19 and other infectious diseases have changed the way people and businesses operate. Social distancing is nowadays a must in order to prevent the spread of such infectious diseases. Unfortunately, with the ease of lockdowns, businesses and governments are still struggling to find solutions for securing the health and safety of their people. Traditional face masks and face shields fail to provide an appropriate remedy to businesses, governments and facility managers for controlling infections in business and public places such as business offices, shopping malls, hospitals, schools, and so on. People are failing to appropriately apply their masks or face shields on a voluntary basis or follow social distancing rules, which is resulting in an increasing number of infections every day.

Also, there are zones which require a more attentive infection control for the infection risk associated to these places (for example highly crowded areas or narrow spaces with small distances between persons). There is a need to restrict access to certain controlled zones to people wearing/using devices such as personal protective equipment (PPE) (for example protection garments, masks and face shields) and complying with certain safety, health and security requirements. Traditional access control systems fail to provide such a control in an automated and technologically smart-manner. They also fail to differentiate between persons complying with certain safety, health, and security requirements (such as properly wearing PPE), and as a result does not help in the reduction and/or prevention of COVID19 and other infections.

### SUMMARY OF THE INVENTION

As a first aspect of the invention, a user device (UD) is configured/adapted to be used by a user for safety or infection control, wherein the user device comprises a smart access control unit (SACU) comprising a communication unit configured/adapted to be in wireless communication with a smart access control device (SACD) for controlling access of the user to a controlled zone based on said wireless communication.

In an embodiment of the present invention, the SACD grants access to the user in response to an access authorization request received from the SACU.

In another embodiment of the present invention, the SACU is configured/adapted to send the access authorization request to the SACD automatically and without human intervention in response to an access control notification signal received from the SACD when the user is within an access control area associated to the controlled zone.

In another embodiment of the present invention, the SACU is configured/adapted to first determine compliance of the user with compliance requirements, such as Health & Safety (H&S) requirements as a condition to sending the access authorization request to the SACD.

In another embodiment of the present invention, the SACU further comprises a PPE use detector to detect a proper use of the personal protective equipment by the user, and the H&S requirements comprise the user is properly using the personal protective equipment.

In another embodiment of the present invention, the PPE uses detector determines whether the user is wearing/using the PPE or, in case the PPE is a smart face protective device having an adjustable face shield, whether the face shield is being secured.

In another embodiment of the present invention, the SACU further comprises a thermal detector for detecting a body temperature of the user, and the H&S requirements further comprise the user's body temperature is below a predefined temperature threshold.

In another embodiment of the present invention, the predefined temperature threshold is 38 degree Celsius.

In another embodiment of the present invention, the SACD is configured/adapted to authenticate the user prior to granting access to the controlled zone, wherein the authentication comprises determining if the user is a pre-approved user based on a user identifier obtained from the user device and a pre-stored list of approved users accessible to the SACD.

In another embodiment of the present invention, the controlled zone is an elevator. In another embodiment of the present invention, the elevator has a floor panel and wherein the SACD is connected to the elevator floor panel for providing a floor selection of the user to be serviced by the elevator.

In another embodiment of the present invention, the floor selection is obtained by the SACD from the SACU and the floor selection is a pre-authorized floor stored in a database accessible to the SACD.

In another embodiment of the present invention, the wireless communication between the SACU and the SACD is either a direct or indirect communication through a proxy device.

In another embodiment of the present invention, the proxy device is a user's smart mobile device running a mobile application configured/adapted to process at least a part of the actions required for the purpose of access control to the controlled zone.

In another embodiment of the present invention, the wireless communication is selected from a group consisting of Near Field Communication (NFC) and Bluetooth Low Energy (BLE).

In another embodiment of the present invention, the SACU is removably coupled or permanently integrated to a wearable, portable or movable user device.

In another embodiment of the present invention, the wearable, portable, or movable user device comprises at least one of an accessory such as a bracelet, a ring, a watch, a pen, a key holder, an official document such as a passport, an identity card, a smart card, a smart document; and a protective equipment such as a protective clothing, a helmet, a face shield, a garment or an equipment designed to protect the user from communicating or contracting infectious diseases, such as COVID-19.

In another embodiment of the present invention, the user device is a smart face protective device configured/adapted to be worn/used by the user for covering the user's portal portion of the face.

In another embodiment of the present invention, the user device is a smart face shield configured/adapted to be used by the user for infection control against infectious diseases such as COVID-19.

As another aspect of the present invention, a smart access control unit (SACU) configured/adapted to be used in connection with a user device is disclosed, the SACU comprising a communication unit configured/adapted to be in wireless communication with a smart access control device (SACD) for controlling access of the user to a controlled zone based on said wireless communication.

In another embodiment of the present invention, a Smart Access Control Device (SACD) for safety or infection control is disclosed, the SACD being configured/adapted to control access of a user to a controlled zone based on a status of the user.

In another embodiment of the present invention, the determining compliance of the user with compliance requirements, such as H&S requirements, is conducted, at least partially, by the SACD.

In another embodiment of the present invention, a smart access control system (SACS) for controlling access to a controlled zone for safety or infection control is disclosed, the system comprising at least one SACU and at least one SACD.

In another embodiment of the present invention, the SACS comprises at least two SACDs: a first SACD at an access-controlled entry for controlling access of the user to the controlled zone based on the compliance of the user to compliance requirements, such as H&S requirements, at the time of requesting access; and a second SACD at an access-controlled exit for controlling exit of the user from the controlled zone based on the user compliance to the H&S requirements of during the entire journey between the entry time the of the user inside the controlled zone until the exit time.

In another embodiment of the present invention, the SACS is connected to an authority system for reporting the user in case of incompliance to the H&S requirements during the journey inside the controlled zone.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a block diagram illustrating a Smart Access Control System (SACS) for comprising a Smart Access Control Device (SACD) in communication with user devices in accordance with an embodiment of the present invention;

FIG. 2 is a block diagram illustrating a User Device (UD) in accordance with an embodiment of the present invention;

FIG. 3 illustrates a Health & Safety Monitoring Unit of a UD in accordance with an embodiment of the present invention;

FIG. 4 illustrates face shield unit of a UD in accordance with an embodiment of the present invention;

FIG. 5 is a block diagram illustrating a Smart Access Control Device (SACD) in accordance with an embodiment of the present invention;

FIG. 6 illustrates a controlled zone deploying a single gate equipped with a first SACD in communication with UDs for controlling access to the controlled zone according to an embodiment of the present invention;

FIG. 7 illustrates a controlled zone deploying an entry gate equipped with a first SACD and an exit gate equipped with a second SACD in communication with UDs for controlling access to the controlled zone according to an embodiment of the present invention;

FIG. 8 illustrates a lift (elevator) equipped with a SACD designed to be in communication with UDs for controlling access to the building (controlled zone) according to an embodiment of the present invention;

FIG. 9 illustrates a plurality of controlled zones deploying a plurality of SACDs in communication with UDs for controlling access to the controlled zones according to an embodiment of the present invention;

FIG. 10 illustrates a plurality of SACDs for controlling access to a single controlled zone having multiple access-controlled entries in communication with UDs according to an embodiment of the present invention;

FIG. 11 illustrates a process of controlling access of users to a gated/controlled zone for infection control in accordance with an embodiment of the present invention;

FIG. 12 illustrates a process of controlling access to a lift (elevator) and providing elevator services in accordance with an embodiment of the present invention; and

FIG. 13 illustrates a User Device Access Control Unit configured/adapted to be coupled to a User Device (UD) in accordance with an embodiment of the present invention.

FIG. 14 is a block diagram illustrating a User Device (UD) in communication with a Smart Mobile Device 90 in accordance with an embodiment of the present invention.

FIG. 15 is a block diagram illustrating an Access Control System 200 for obtaining user-related data from collection devices, and controlling access to users to controlled zones based on the obtained user-related data.

### DETAILED DESCRIPTION OF THE INVENTION

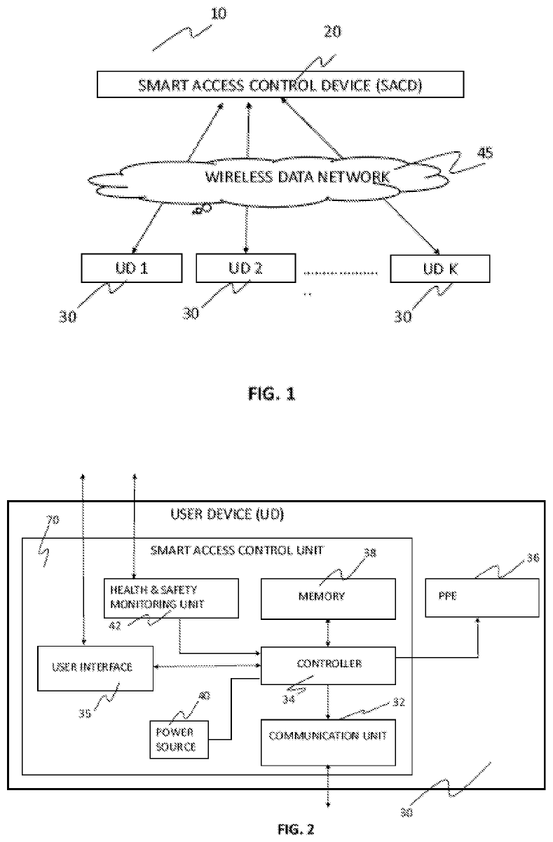

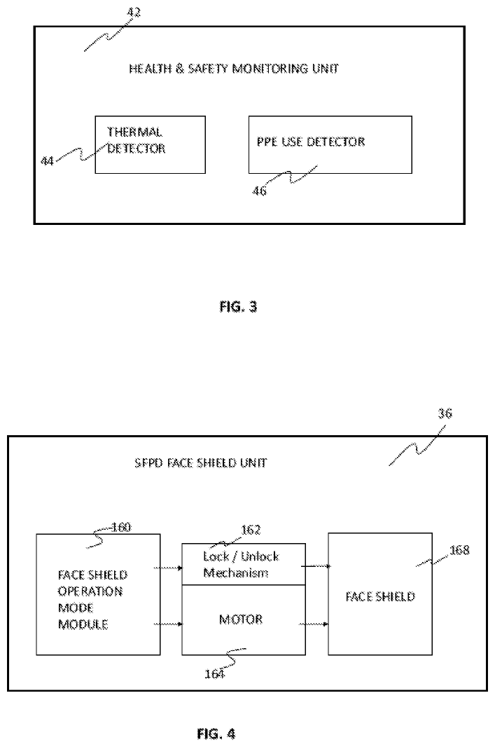

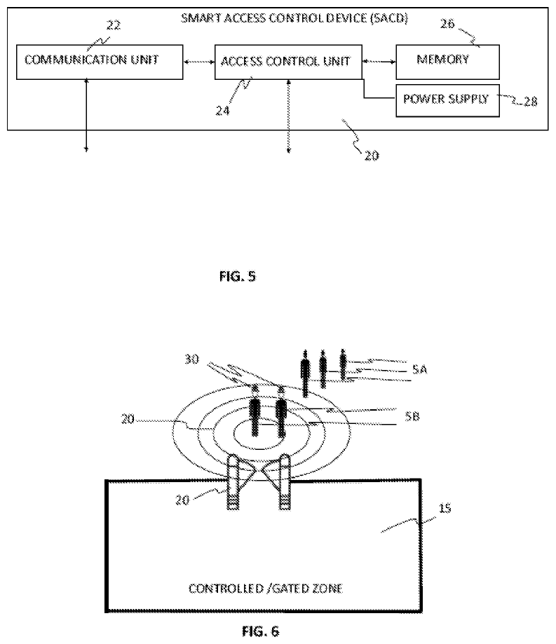

The aspects of the invention will be described in conjunction with FIGS. 1-15. In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

Referring to FIGS. 1-5, there is provided a Smart Access Control System (SACS) 10 for controlling access of users to a controlled zone 15 based on a status of the user. The status of the user may comprise a legal or regulatory status or profile of the user such as legal status inside a country, work permit status, country of citizenship or residency, regulatory compliance and so on. The status of the user may also comprise compliance requirements, such as health and safety conditions associated to the users such as real time health conditions of the users or pre stored health data such as medical check out history and previously generated medical tests in order to enhanced compliance, safety, security and control spread of infectious diseases between the users and others inside the controlled zone 15. In an embodiment of the invention the health and safety condition of the users is determined, at least in part, based on whether the users are using PPE (for example wearing a smart face protective device which can comprise a mask, a shield or a helmet covering at least the portal portion of their faces) in order to prevent/reduce the spread of any infectious diseases.

According to an embodiment of the invention, the PPE may be a Smart Face Protective Device (SFPD). The present detailed description of the invention and related drawings will be explained, at least in part, in relation to a UD 30 comprising or consisting of a SFPD for exemplary purposes only, however a person skilled in the art would appreciate that the various embodiments of the present invention applicable to a SFPD may extend to any PPE such as clothing, a garment, a goggle, a helmet, a face shield or any other personal protective equipment which can be applied without departing from the scope of the invention with or without making any minor adjustments depending on the application.

In an embodiment of the invention, the SACS 10 comprises a SACD 20 and a plurality of UDs 30 associated with users. Each UD 30 may be associated with a specific user such as an identification of the UD 30 allows for uniquely identifying the user. A UD 30 may be a user identification device for uniquely identifying the user. The UD 30 may be a wearable device, a portable device, or a movable device associated with a new user. A UD 30 may comprise a PPE such as a smart face protective device configured/adapted to be worn/used by users for protecting their faces against the spread of infectious disease between them and with others. The UD 30 may also be an electronic chip or circuitry associated to a user. The UD 30 may also be an identification or authentication device such as a face recognition device or a biometric authentication device. The LID 30 may also be a smart device or a mobile device.

The UD 30 may comprise or consist of or be couplable to an accessory configured to be accompanied, held or worn/used by the user such as a bracelet, a ring, a watch, a pen, and a key holder. The UD 30 may also comprise or consist of or be couplable to an official object or document associated to the user, such as a passport, an identity card, a smart card, a smart document. The UD 30 may also be integrated, positioned, or otherwise part of a movable object such as a vehicle associated to the user. The UD 30 may also comprise or consist of or be couplable to a PPE, such as a protective clothing, a helmet, a face shield, a garment, or an equipment designed to protect the user from infectious diseases, such as Covid-19. The UD 30 may also be, depending on the application, a device or system which is configured to identify the user in a specific location, such as a user authentication system, a face recognition system or a biometric identification/authentication system. The UD 30 may also be a system which may be used to identify a group of users, depending on the application.

In an embodiment of the invention, there is provided a UD 30 configured/adapted to identify a user for safety, security or infection control, wherein the UD 30 is configured/adapted to be in wireless communication with a SACD 20 for controlling access of the user to a controlled zone 15 based on said wireless communication. The UD 30 may also provide an indication of a status of the user for access control purposes.

In an embodiment of the invention, there is provided a SACD 20 configured/adapted to be in wireless communication with UDs 30 for controlling access of users to the controlled zone based on a status or one more conditions of the users, such as health and safety conditions of the users (which may be determined at least partially by the UDs 30). The wireless communication between the SACD 20 and the UDs 30 can be a NFC peer-to-peer communication, a BLE communication, a RFID communication, or any other suitable type of wireless communication depending on the application such as LPWAN.

The UD 30 may provide a seamless access control to the user using the wireless communication with the SACD 20. The seamless access control may control access of the user to a plurality of controlled zones having respective access control requirements. Each controlled zone may have access control requirements (in relation to the user) distinct from the access control requirements associated to the other controlled zones. Each controlled zone may have its respective SACD 20. The user, through its associated UD 30, may be controlled access to the plurality of access controlled zones. A single UD 30 may enable to control access of the user to the plurality of the controlled zones according to various access control requirements.

The seamless access control may also provide an automated access to the user through an automated detection of the user or the smart device and an automated verification of the status of the user with respect to the access control requirements. Verification of the status of the user with respect to the access control requirements may require comparing user related data to the access control requirements. The user related data may be detected or otherwise obtained in real time at the time of controlling access of the user to the controlled zone, or may be obtained and stored in advance. The previously stored user related data may be used for status verification at the time of controlling access or previously. The seamless access control may not require any distinct or independent action by the user to request or trigger an access control action to the controlled zones. The seamless access control may be conducted seamlessly without the knowledge of the user and may act in the background to control access of the user to various controlled zones, systems or actions.

The user related data may be obtained by the UD 30, the SACD 20, or an independent device in communication and/or coordination with the UD 30 and/or the SACD 20 depending on the configuration. The user related data may be stored locally in the UD 30 and/or the SACD 20. The user related data may also be stored in a remote storage database 220 which can be located on a data cloud network.

The UD 30 and/or the SACD 20 may comprise one or more communication units for obtaining the user related data from the cloud-based database 220 as needed for access control purposes. The one or more communication units may comprise one or more transmitters and one or more receivers (also called transceivers).

The communication technology, transceivers and data communication protocols used may be based on any suitable technology depending on the application, such as RE, RFID, NEC, BLE, and Low Power Wide Area Network (LPWAN). The communication technology and network may be built using Sigfox, LoRa, NB-IoT, and LTE-M.

The processing of the user related data in view of the access control requirements in order to control user access may be conducted locally at the level of the user device or the SACD 20, and it may also be conducted using a remote processing unit in a remote system or a remote server 210 in communication with the UD 30 and/or the SACD 20. The remote data processing unit/remote system/remote server may be located on a data cloud network, and the communication with the SACD 20 can be conducted using any suitable communication technology such as TCP/IP, GSM, RF or LPWAN.

The determination of the status of the user may require using data collection devices 205, which tray comprise detectors, sensors, tracking devices, positioning devices, health monitoring devices, mental/behavioural assessment devices, mood detection devices, and other electronic components configured to obtain at least a part of the user related data. The collection devices may also include existing databases such as immigration databases to track the exit/entry of users inside a country for example, medical databases to obtain medical data in relation to the users such as medical results, security or judicial clearance databases to obtain security data in relation to the users such as criminal records, governmental databases to obtain regulatory, legal or medical status of the users and so on. The collection devices 205 may also include a mobile device of the user to track any information on the mobile device which may constitute an impact on safety and security and which may impact access control to some controlled zones. The collection devices 205 may also comprise user interfaces for manually posting certain date related to the users by authorized parties. The data collection devices may be connected to the UD 30 and/or the SACD 20 for providing the user related data relevant to SACD 20 in question. The data collection devices 205 may also be connected to the remote storage database 220 for storing the user related data obtained using the data collection devices 205, The data collection devices 205 may comprise communication units comprising transmitters for transmitting the collected user data to the UD 30 and/or the SACD 20 and/or to the remote storage database 220 for storage as required. The transmitters may use any suitable communication technology, wired or wireless, such as LPWAN particularly when the user related data is collected and transmitted to a cloud-based remote storage database 220.

The data collection devices 205 may comprise health monitoring devices to detect/obtain a health condition of the user such as temperature, virus or bacterial infection, and any other biological, chemical, physiological or psychological condition. The data collection devices 205 may also comprise devices configured to monitor behavioral, psychological and/or physiological aspects related to the user such as frequency of presence at specific locations and nonverbal gestures which may be indicative of noncompliance with a given access control requirement such as a possible intention for a safety/security breach for example.

The controlled zones may comprise a controlled access to gated or ungated locations or physical zones. The controlled zones may also comprise controlled devices, systems or equipment which operation is controlled such as public vehicles, arms, aircrafts and the like. Controlling the access to controlled zones may comprise restricting the physical access to the controlled zones in case of gated physical zones, and it may comprise (particularly in case of ungated zones) notifying the user of the restricted access to the controlled zones through the UD 30 or another communication device through for example a mobile application or map showing the various zones and access rights associated to the user, A map may be provided to show the location of a group of users on the map based on the identification of users using the UD 30 which may show crowds in specific locations.

The users may also be compiled and highlighted on the map based on one or more selection criteria using their respective collected user related data and/or access rights in light of the access control requirements. A system, such as the remote system 210 may be configured for this purpose. For example, the users may be compiled based on two or more groups depending on the compilation criteria which may comprise medical status, professional status, national origin, legal status and the like. Users belonging to a given group can be managed collectively by managing group access control rights, guiding and/or notifying them on restricted/allowed controlled zones and so on. The map may divide and illustrate the various categories of users, for example a red category and a green category, where users in the red category shall not be mixed with users in the green category for various reasons (for example health or security reasons). Users in red (User Group A) can be managed collectively by guiding/allowing access to them to first controlled zones only (controlled zones A) and users in green category (User Group B) may be managed collectively by guiding/allowing access to them to second controlled zones different from the first controlled zones (controlled zones B). The first and second controlled zones A and B may also be a different time period allocation to the different user groups A and B in relation to a same physical zone. A system such as the remote system 210, comprising a processing unit, may be provided which may be in communication with the UDs 30, the SACDs 20, the collection devices 205 and/or the remote storage database 220 and other devices part of the network.

Controlling access to controlled zones may also comprise disabling or enabling or controlling in any other suitable manner the operation of the controlled devices, systems or equipment as a function of the user related data and access control requirements. Controlling access to controlled zones may also comprise enabling or disabling the users to make certain actions a priori, or enabling or disabling certain actions a posteriori conducted by the users.

The controlled zones may be public vehicles such as cabs, and controlling access to these vehicles may comprise restricting the operation of the vehicles. The SACD 20 may be connected to one or more components of the vehicles in this case to enable/disable operation of the vehicles or a component of the vehicle based on the access rights associated to the user which may be determined based on user related data and access control requirements.

The SACD 20 may also be connected to notification devices to notify the users or third parties about the access rights to a user. The UDs 30 may comprise the notification units for communicating with the users. For example, a public vehicle may comprise a notification unit (such as a display) connected to the SACD 20 for displaying the status of the user (driver or passenger in this case) and whether the user is authorized to operate or take a public vehicle. For example, passengers or drivers who have not taken a virus vaccine may not be authorized to drive/take a public vehicle. A UD 30 in the form of a wearable device may also flag a red light in case the user is heading towards a controlled zone not accessible to a user.

The UDs 30 may be in real time communication with the remote system 210 for obtaining access rights in relation to the users. The remote system 210 may also send to each one of the UDs 30/SACDs 20 an access control table for local storage inside the UDs 30/SACD 20 with an indication of the users' access rights related to the SACDs 20. The access control can then be conducted locally between the UDs 30 and the SACDs 20 using the access control table. The users' access rights may be compiled by the remote system 210 on a regular basis, and the access control tables can be sent to the UDs 30/SACD 20 for being updated every given period of time, such as on a daily basis. An access control rights table associated to a specific user A may comprise a list of SACDs 20 to which user A has access, which can be stored in the user device associated to user A. An access control rights table associated to a specific SACD 20 (SACD A) may comprise a list of UDs 30 which have access to that specific SACD A, which can be stored in the SACD A 20. The access control processing between users and the SACDs 20 is then conducted locally by the user devices 30 and SACDs 20.

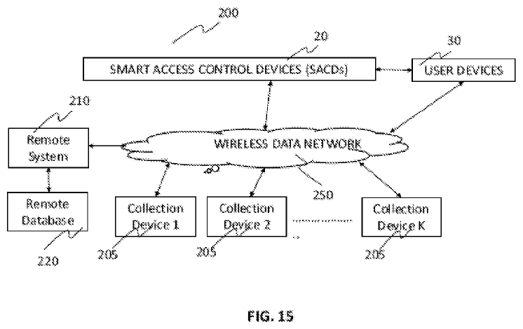

As illustrated in FIG. 15, a system 20 may be provided comprising UDs 30, access control devices 20, collection devices 205, a remote system 210, a remote storage database 220. At least some of the components of the system 200 may be cloud-based and the various components of the system 200 may communicate via a wireless data network 250.

In an embodiment of the invention, the UD 30 comprises a smart face protective device (SFPD) configured/adapted to be worn by a user for preventing or reducing spread of infectious droplets through a portal portion of the user's face, where the SFPD is configured/adapted to wirelessly communicate with the SACD 20 for access control/authorization of the user (wearing the SFPD) inside the controlled zone 15.

In an embodiment of the invention, the wireless communication between the SACD 20 and the UD 30 is conducted while the UD 30-wearing user is in proximity of the access-controlled entry associated to the controlled zone 15. Based on the communication between the SACD 20 and the UD 30, user is granted or denied access to the controlled zone 15. In an embodiment of the invention, the access control/authorization is conducted automatically between the SACD 20 and the UD 30 without any user or human intervention while the UD 30 is in proximity of the access-controlled entry of the controlled zone 15. In an embodiment of the invention, the establishment of the wireless communication between the SACD 20 and the UD 30 is itself sufficient for granting the user access to the controlled zone 15. This may be as the establishment of the communication between SACD 20 & UD 30 is an evidence that the user is using the UD 30 which is sufficient to grant him access to the controlled zone 15 as having taken the required measures to protect himself and others against the spread of infectious diseases. In an embodiment of the invention, the SACD 20 is configured/adapted to grant access inside the controlled zone 15 to UD 30 users only (if they meet any other conditions required), and to deny access to all other non-protected users. The SACD 20 authorizes access exclusively to users wearing/using a UD 30, and refuse access to all users not wearing a UD 30. In an embodiment of the invention, the UDs 30 are configured/adapted to be worn/used by users for both prevention/protection and authorization/access control purposes in order to gain access to the controlled zone 15 through the SACD 20. Authorization of the users for gaining access to the controlled zone 15 by the SACD 20 is therefore at least partially based on whether they are wearing/using (and are protected/compliant to access control conditions) by a UD 30 which is a condition precedent to have access authorization to the controlled zone 15. In some applications, wearing/using the UD 30 is itself sufficient to grant a user access to the controlled zone 15. In other applications, other or further conditions are required to be met (such as an authentication of the user or a determination of a good health of the user) before granting such access.

In an embodiment of the invention, the UD 30 is a portable device and wearing/using the UD 30 is a condition for a user to have access to the controlled zone 15, and therefore access authorization inside the controlled zone 15 by the SACD 20 requires, at the minimum, the detection of the UD 30 in proximity of the access-controlled entry. In an embodiment of the invention, this detection of the UD 30 in proximity of the access-controlled entry is determined through the wireless communication being established between the SACD 20 and the UD 30.

In an embodiment of the invention, depending on the application, users are also required to be pre-registered users with pre-approved access rights to the controlled zone 15 in order for them to have access to the controlled zone 15 provided they are wearing/using the UD 30. According to this embodiment, a further authentication of the users is required. Other conditions might also be required in order to gain access to the controlled zone 15, depending on the application, such as a determination of a good health condition associated to the user (such as the user's body temperature for example). In an embodiment of the invention, the UD 30 is equipped to authenticate the user, as well as to monitor and provide as status of his health condition required for access authorization purposes.

In an embodiment of the invention, the UD 30 automatically obtains and sends access control information to the SACD 20 for access control/authorization purposes without any requirement for the user to touch the SACD 20 or any other external device as an infection control measure. In an embodiment of the invention, at least a part of the access control information is automatically detected and/or transmitted by the UD 30 to the SACD 20 without any user intervention (or any other human intervention). In an embodiment of the invention, the wireless communication between the UD 30 and the SACD 20 is based on at least one of the following wireless technologies: Radio Frequency Identification (RFID), Bluetooth Low Energy (BLE), Near Field Communication (NFC), Wi-Fi, 3/4/5G, and Ultra-Wide Band (UWB). In an embodiment of the invention, the access control signal (also called the access authorization request) transmitted by the UD 30 to the SACD 20 during the establishment of the wireless communication between SACD 20 & UD 30 comprises a simple notification confirming presence of a UD 30 which is indicative that the user requesting access authorization at the access-controlled entry is wearing/using by a UD 30. In an embodiment of the invention, the access control signal comprises a unique identifier enabling to uniquely identify the UD 30/the associated user (called the user identifier). The user identifier is being processed by the SACD 20 to determine if there is a match between the received identifier and pre-stored identifiers associated to pre-registered and pre-approved users. The SACD 20 provides access authorization to the user only if there is a match determined with the user identifier communicated by the UD 30. Otherwise, in case no match is found, user access to the controlled zone 15 is denied.

In an embodiment of the invention, the SACD 20 is connected to an access control database (not shown) for storing and keeping in record all access related information comprising a list of users and respective dates and times who are granted access to the controlled zone by the SACD 20. Preferably, the SACD 20 also communicates with the UDs 30 while the users are exiting the controlled zone 15 and keep in record exit information (such as date and time, and any information related to the effective wearing/using—or lack of wearing/using—the UD 30 and other status conditions during the journey such as health conditions like temperature) related to the users. This access/exit information related to the users are also stored in the access control database (not shown). This access related information stored in the access control database can be used by an administrator for management purposes, including tracking any user for any health or safety reason.

In an embodiment of the invention, the UD 30 monitors the effective use/wear of the UD 30 during the entire journey between the time the user accessed the controlled zone 15 until the exit time. In an embodiment of the invention, the UD 30 notifies the SACD 20 at the exit point (such as if the user took off the SFPD 30 during that journey). In an embodiment of the invention, the SACD 20 denies granting an exit permission to the user if the record shows that he did not wear/use the UD 30 (at any point of time, or during a predefined period of time) inside the controlled zone 15. The SACD 20 is configured/adapted to be connected to the relevant authorities (such as the security guards or police or administrator of the controlled zone) to notify of such a breach. This can lead to repercussions such as fine or imprisonment. In an embodiment of the invention, the SACD 20 is connected to a user account for automatically issuing a fine in connection with the user in case of noncompliance.

In an embodiment of the invention, the SACD 20 is configured/adapted to authorize access to the user only subsequent to receiving a confirmation from the UD 30 that the user is effectively wearing/using the UD 30 on a basis of a sensor signal received by the UD 30 (and preferably the sensor signal being generated by a PPE use detector 46 located at the UD itself) confirming that the UD 30 is being worn/used by the user. This may be in order to control access against users trying to illegitimately overcome the SACD 20 by carrying the UD 30 without properly wearing/using the device which may impact the accuracy of assessing some of the access control conditions associated to the users such as PPE use or temperature scanning. This is as, absence such a control on the proper wear of the UD 30 through a sensor signal confirming the same, the UD 30 might still be detected by the SACD 20 while it is being carried by the user at the access-controlled entry without proper wear/use/assessment of some of the access control conditions and the user might still be authorized access to the controlled zone 15. This measure will be able to differentiate between carrying the UD 30 without properly wearing/using the device 30, and the proper wear/use of the device 30.

In an embodiment of the invention, the UD 30 comprises a face shield 36 adjustable between a secured and an unsecured position (such as face shield closed and face shield open respectively. According to this embodiment, the access control signal (also called the access authorization request) comprises an indication of whether the face shield is being adjusted in a secured position such that a portal portion (eyes, nose and mouth) of the user's face are being covered. The secured position is a position in which the portal portion of the user's face (eyes, nose and mouth) is isolated from the external environment for blocking spread of splashes and sprays between the user and other individuals (or objects within the controlled zone) through said portal portion and for blocking hands or other members or objects from reaching to said portal portion of the face. The SACD 20 grants authorization access to the user only if the face shield 36 is adjusted in the secured position.

In an embodiment of the invention, the UD 30 sends an access authorization request to the SACD 20 only in case the SFPD 30 is determined to be effectively worn by the user (or the face shield 36 being adjusted in the secured position). According to this embodiment, a receipt of such an access authorization signal by the SACD 20 is indicative in itself of the proper wearing of the SFPD 30 by the user, and on this basis, user access is authorized by the SACD 20 inside the controlled zone 15. In an embodiment of the invention, the proper wear of the UD 30 (and other required conditions such as the compliance with a health or safety condition) is being controlled a priori by the UD 30 itself as a condition to sending an access authorization request (and not by the SACD 20). Authentication of the user (if any) is however controlled by the SACD 20. In an embodiment of the invention, the UD 30 comprises a PPE, preferably a smart face protective device (SFPD), configured/adapted to be adjusted automatically (hands-free and without user intervention while being worn/used by the user) in a secured position based on a signal received from the SACD 20 as a condition to granting the user (wearing/using the UD 30) access to the controlled zone 15. In an embodiment of the invention, the SACD 20 is configured/adapted to transmit access control notification signals in proximity of the access-controlled entry (also called the access control area) associated to the SACD 20. The UDs 30 within the access control area at the access-controlled entry are configured/adapted to capture and respond to the access control notification signals by automatically transmitting to the SACD 20 access control signals (also called access authorization requests or access authorization request signals).

In an embodiment of the invention, the SACD 20 is configured/adapted to send access control notification signals on a periodic or regular basis and the UDs 30 are configured/adapted to continuously scan for such signals, capture and process these access control notification signals for determining the physical proximity of the UDs 30 with respect to the SACD 20. If a UD 30 is determined to be within the access control area at the access-controlled entry of the SACD 20 (which can be determined based on the strength of the signal received for example), then the UD 30 is configured/adapted to transmit an access control signal to the SACD 20 (comprising the access control information if required depending on the application) for providing access authorization to the user. According to this embodiment, the wireless technology used to communicate between the SACD 20 and the UD 30 is preferably Bluetooth Low Energy (BLE).

In an embodiment of the invention, the SACD 20 comprises a communication unit 22 comprising an active wireless communication device continuously transmitting control access notification signals and the UD 30 comprises a communication unit 32 comprising a passive wireless communication device being excited when a control access notification signal is being received. The excitation of the passive wireless communication device of the UD 30 triggers the UD 30 to automatically (without human intervention) transmit an access control signal (comprising the access control information if required depending on the application) to the SACD 20. According to this embodiment, the wireless technology used to communicate between the SACD 20 and the UD 30 is preferably Near Field Communication (NFC) or Radio Frequency Identification (RFID). In an embodiment of the invention, the communication unit 22 of the SACD 20 acts as a beacon, and the communication unit 32 of the UDs 30 acts as a scanning device. The SACD 20 periodically send access control notification signals, and UDs 30 continuously scan these signals. When a UD 30 approaches an access-controlled entry related to the SACD 20, the access control notification signal strength increases in value. The UD 30 is configured/adapted to compare the strength of the access control notification signal received to the signal strength threshold as predefined by the UD 30. If the strength of the access control notification signal received is above the predefined signal strength threshold, then the UD 30 comes to a determination that the user is at the access-controlled entry of the SACD 30 and automatically sends an access control signal to the SACD 20. This is preferably conducted automatically, hands-free and without any user intervention.

The SACD 30 is configured/adapted to transmit signals having suitable wireless signal characteristics, including frequency and power, capable of being detected by the UDs 30 while these are within the access control area at the access-controlled entry. The wireless technology and signal characteristics can vary depending on the application. In an embodiment of the invention, the SACD 20 comprises a SACD communication unit 22, a SACD access control unit 24, a SACD memory 26 and a SACD power supply 28 for providing power to the electronic components of the SACD 20. In an embodiment of the invention, the SACD communication unit 22 comprises a reader/receiver for receiving the access control signal (comprising the access control information) from the UD 30 through the wireless data network 45 and to transmit the access control information to the SACD Control Access Unit 24. The SACD Control Access Unit 24 comprises a processor or controller configured/adapted to process the access control information based on predefined access control requirements (conditions) stored inside the SACD memory 26, and to grant or deny access to the user based on the processing of the access control information as a function of the access control conditions.

In an embodiment of the invention, the receiver/reader 22 of the SACD 20 is preferably located at a suitable height from the ground such that the UD transmitter 32 is within a suitable wireless connectivity distance range when a user wearing the UD 30 passes through the access-controlled entry. Depending on the application, the SACD 20 can be provided with a support structure for receiving and positioning the SACD reader 22 at the suitable height such that the UD 30 is positioned within the wireless connectivity distance range when the user is passing through the access-controlled entry. The height of the reader 22 with respect to the ground is preferably in the range of 165 cm to 185 cm, as this aligns with the average height range of a person. In an embodiment of the invention, the wireless technology used to establish the wireless communication between the SACD 20 and the UD 30 is NFC, and the wireless connectivity distance range in this case is around 30 centimeters. The wireless connectivity distance range can be adjusted as required depending on the wireless technology used and the typography of the access-controlled entry. This adjustment may comprise adjusting the signal characteristics such as the power and frequency. The wireless technology selected may also depend on the wireless connectivity distance range required based on the typograph of the access-controlled entry. The wireless technology used is preferably selected from BLE, NFC, RFID, and UWB.

In an embodiment of the invention, a receipt of the access control signal by the SACD 20 from the UD 30 is indication of the presence of a UD 30 at the access-controlled entry and is sufficient for granting access to the user by the SACD Access Control Unit 24. According to this embodiment, access to the controlled zone 15 is granted to all users holding/wearing/using a UD 30 and as such the detection of the UD 30 by the SACD 20 within the access control area is in itself sufficient for granting access to the user inside the controlled zone 15. According to this embodiment, UD 30 users present to the SACD 20 access-controlled entry wearing/using their respective UDs 30 and they are automatically (and without human intervention) being detected by the SACD 20 through their respective UDs 30 and granted access to the controlled zone 15. All other users (not wearing UDs 30) are therefore being denied access.

In an embodiment of the invention, the UD 30 comprises a controller 34 and a communication unit 32 (comprising at least a transmitter, and preferably a transceiver) for transmitting the access control signal to the SACD 20 for authorizing access to the user inside the controlled zone 15. In an embodiment of the invention, the communication unit 32 of the UD 30 further comprises a receiver for receiving signals from the SACD 20 (such as the access control notification signals in response to which the access control signal is being transmitted by the UD 30). In an embodiment of the invention, the authorization process comprises determining if the user wearing the UD 30 is a pre-registered/pre-approved user according to a list of pre-approved users. In an embodiment of the invention, the UD 30 further comprises a memory 38 for storing a user identifier, wherein the controller 34 extracts the user identifier from the memory 38 and sends it as part of the access control signal to the SACD 20 for user authentication purposes. In an embodiment of the invention, the SACD reader/receiver 22 is configured/adapted to receive from the UD communication unit 32 a unique identifier associated to the UD 30 and/or associated user. The SACD Access Control Unit 24 is configured/adapted to determine based on the information received from the UD 30 whether the user is a registered user within the SACD memory 26. If it is the case, access is granted and instructions are sent by the SACD Access Control Unit 24 to the gate or other access device for allowing access to the user.

According to this embodiment, the UD 30 stores a unique identifier associated to the user inside the UD memory 38. The user unique identifier is extracted by the UD controller 34 from the UD memory 38 and transmitted by the UD transmitter 32 as part of the access control information to the SACD 20. The unique identifier enables to uniquely identify the UD 30 and/or associated user wearing the UD 30 and this information is being used by the SACD Access Control Unit 24 during the authorization process. The SACD reader/receiver 22 receives the access control information and transmits it to the SACD Access Control Unit 24. During the authorization/authentication process, the SACD Access Control Unit 24 determines if the user is a pre-registered/pre-approved user based on the user unique identifier received and on pre-approved identifiers related to pre-registered/pre-approved users. According to this embodiment, the SACD memory 26 stores pre-registered/pre-approved users related identifiers (and other credentials) which are searched by the SACD Access Control Unit 24 during the authentication process to determine if there is a match with the user unique identifier received. Only authenticated pre-registered/approved UD users are granted access to the controlled zone 15. This authentication process is preferably conducted automatically and without any human intervention, including obtaining and transmitting the access control information by the UD 30 and the receipt and the processing of the access control information by the SACD 20 and the control access actions taken by the SACD 20 to grant or deny user access based on said processing.

In an embodiment of the invention, the unique identifier can be static or dynamic such that it can be updated to reflect the identity of the user using the UD 30 at any given time. In an embodiment of the invention, the user interface 35 of the UD 30 is configured/adapted to enable the set up/change of the unique identifier based on the identity of the user using the device 30. In an embodiment of the invention, the user interface 35 comprises at least one connector configured/adapted to be connected to an external electronic device 90 for enabling a connection between the UD 30 and the external electronic device 90. The external electronic device 90 can be an external battery or power supply for providing power to the UD 30 (such as charging an internal battery). The external electronic device can also be a smart device accessory such as ear phones. At least one connector preferably comprises a USB connector and a Bluetooth connector. The connector is preferably connected to the controller 34 and the power supply 40 (and other components as required depending on the application).

In an embodiment of the invention, the UD 30 further comprises a Health & Safety (H&S) Monitoring Unit 42 for monitoring at least one health or safety condition associated to the user which is taken into account during the access control authorization process. The H&S Monitoring Unit 42 may also be an external system or device (such as an infrared thermal device or drug or alcohol or virus detection device) adapted/configured to be connected to the UD 30 and/or to the SACD 20. A connector may be provided between the H&S monitoring unit 42 and the SACD or the UD 30 as applicable to convert the signals between the devices based on the communication protocols of the communicating devices 42, 20, and 30. A connector/converter may also be provided to connect between the H&S Monitoring Unit 42 and UD 30 and/or the SACD 20.

In an embodiment of the invention, the access control information comprises an indication of the health and safety condition of the user according to a reading obtained from the UD H&S Monitoring Unit 42 and transmitted to the UD controller 34. The SACD 20 denies access if the health or safety condition of the user is not in compliance with predefined health and safety requirements (H&S requirements). In an embodiment of the invention, the UD 30 transmits an access authorization request to the SACD 20 only if/when the health and safety condition of the user is in compliance with the predefined health and safety requirements (as determined by the UD Controller 34 in conjunction with the UD H&S Monitoring Unit 42), and as such only users complying to the predefined H&S requirements as determined by units 34 & 42 are being authorized by the SACD 20 and granted access to the controlled zone 15 when they comply with any other access conditions.

In an embodiment of the invention, the Health & Safety Monitoring Unit 42 comprises a thermal detector 44 for monitoring a body temperature of the user, and wherein the H&S requirements comprise the user's temperature being below a predefined temperature threshold. In an embodiment of the invention, the thermal detector 44 comprises a non-contact infrared sensor (IR) preferably mounted in a position pointing at a hairless body part, such as the arm or forehead of the user when the UD 30 is being worn/used by the user, for measuring the user's temperature through the user's hairless body part. When the user device 30 comprises a bracelet or a ring, a thermal sensor is provided within the housing of the bracelet or the ring such that a body temperature of the user can be obtained.

In an embodiment of the invention, the predefined temperature threshold is around 38 degrees Celsius. If the user's temperature is beyond said temperature threshold, the user is denied access to the controlled zone 15 as this may be indicative of the user being infected by an infectious virus such as COVID-19. In an embodiment of the invention, the Health & Safety Monitoring Unit 42 comprises a UD use detector 46 configured/adapted to determine if the UD 30 is actually being worn/used by the user. The UD use detector 46 comprises a sensor to detect if the user is actually wearing the UD 30 (and not only holding it by hand for example). The sensor can be a pressure, touch or push sensor, for example positioned within the UD 30 such that the sensor is triggered when the UD 30 is being worn, or can be a thermal detector which detects the body temperature of the user when the UD 30 is being worn. The sensor can also be an optical sensor (such as a camera), or any other suitable type of sensor depending on the shape and structure of the UD 30 as well as on the application.

In an embodiment of the invention, the UD use detector 46 is further configured/adapted to detect whether the face shield is being adjusted in a secured position (in the case where the face shield is adjustable between an unsecured position and a secured position). Preferably, the same IR sensor used by the thermal detector 44 is being used as part of the UD use detector 46 for detecting whether the UD 30 is being worn/used by the user depending on the temperature detected. This is as when the UD 30 is being worn/used, the IR sensor will be pointing to the forehead of the user and therefore detecting a body temperature of the user which should be above 37 degrees Celsius. A temperature below a certain temperature threshold (37 or 36.5 degrees Celsius for example) is indicative of the UD 30 not being worn/used by the user.

In an embodiment of the invention, the access control information comprises an indication if the UD 30 is being worn/used by the user according to a reading obtained from the UD use detector 46 and transmitted to the UD controller 34. The SACD 20 denies access if the UD 30 is determined not to be worn/used by the user. In an embodiment of the invention, the UD 30 transmits an access control signal (also called access authorization request) to the SACD 20 only if/when the UD 30 is being worn/used by the user (as determined by the UD Controller 34 in conjunction with the PPE Use Detector 46), and as such only users with effectively worn/used UDs 30 as determined by units 34 & 46 are being authorized by the SACD 20 and granted access to the controlled zone 15 when they comply with any other access conditions.

In an embodiment of the invention, the UD 30 comprises a face shield 168 being adjustable between a secured and an unsecured positon (e.g. closed and open positions respectively where the closed position covers the face of the user and the open positon uncovers the face of the user). According to this embodiment, the Health & Safety Monitoring Unit 42 preferably comprises a face shield use detector 46 configured/adapted to detect whether the face shield 168 is in the secured position protecting the user's portal portion of the face. The face shield use detector 46 comprises a sensor to detect if the face shield 168 is being adjusted in the secured position (and not only holding it by hand for example). The sensor can be of any suitable type depending on the shape and structure of the face shield and the UD 30. In an embodiment of the invention, the access control information comprises an indication if the face shield 168 is being adjusted in the secured position according to a reading obtained from the face shield use detector 46 and transmitted to the UD controller 34. The SACD 20 denies access if the face shield is determined not to be in the secured position.

In an embodiment of the invention, the UD 30 transmits an access authorization request to the SACD 20 only if/when the face shield is being secured by the user (as determined by the UD Controller 34 in conjunction with the Face Shield Use Detector 46), and as such only users with effectively worn/used UDs 30 with secured face shields as determined by units 34 & 46 are being authorized by the SACD 20 and granted access to the controlled zone 15 when they comply with any other access conditions. In an embodiment of the invention, the face shield is being automatically adjusted in the secured position by the UD controller 34 when the UD 30 is within the access control area of the SACD 20. To this end, the UD 30 preferably comprises a motor 164 in communication with the UD controller 34 (directly or indirectly through a face shield operation mode module 160), the motor being capable of automatically adjusting the face shield 168 in the secured position at the receipt of a signal from the UD controller 34. The face shield 168 can also be locked in place by a lock/unlock mechanism 162 as long as the user is within the controlled zone 15.

In an embodiment of the invention, the controller 34 is connected to the H&S monitoring unit 42 for receiving the user's temperature and an indication of whether the UD 30 is being wore by the user. In an embodiment of the invention, the controller 34 determines if the user's temperature is beyond a predefined temperature threshold which may be indicative of the user being infected. In an embodiment of the invention, the controller 34 does not send an access authorization request signal to the SACD 20 if the temperature of the user is beyond the predefined temperature threshold (for example 38 degrees Celsius) and therefore the user is not authorized access by the SACD 20 absence of receiving an access control signal from the UD 30. In an alternative embodiment of the invention, the controller 34 sends an indication of the user's high temperature to the SACD 20 as part of the access control information and access of the user is denied by the SACD 20 after processing the received access control information from the UD 30.

In an embodiment of the invention, the controller 34 determines if the user is wearing/using the UD 30 (or if the face shield is being secured) based on the signal received from the H&S monitoring unit 42. In an embodiment of the invention, the controller 34 does not send an access authorization signal to the SACD 20 if the UD 30 is not being worn/used by the user/face shield is not being in the secured position, and therefore the user is not authorized access by the SACD 20 absence of receiving an access control signal from the UD 30. In an alternative embodiment of the invention, the controller 34 sends an indication of the user's not wearing the UD 30/having the face shield secured to the SACD 20 as part of the access control information and access of the user is denied by the SACD 20 after processing the received access control information from the UD 30. In an embodiment of the invention, the UD 30 further comprises a user interface 35 for enabling the user to input information for communication by the UD 30 to the SACD 20, such as the user unique identifier, a floor number, an office number, or any other type of information configured/adapted to be received and processed by the SACD 20.

In an embodiment of the invention, the user interface 35 is connected with the controller 34 for enabling the information entered by the user through the user interface 35 being processed by the controller 34 according to predefined criteria. In an embodiment of the invention, the user interface 35 is configured/adapted to receive a signal from the user for establishing a wireless communication with the SACD 20 for the purpose of seeking access authorization. The signal from the user triggers the UD 30 to send an access authorization request to the SACD 20. The user interface 35 preferably comprises at least one of a touch user interface such as a keyboard and a voice user interface.

In an embodiment of the invention, the user interface 35 is configured/adapted to enable the user to provide access control information such as the user identifier and other credentials for transmission by the UD 30 to the SACD 20 as part of the access control process. In an embodiment of the invention, the user interface 35 is configured/adapted to enable the user to provide any other type of information (such as service information) and the UD 30 is configured/adapted to transmit such information to the SACD 20 as required depending on the application. In an embodiment of the invention, the UD 30 acts as a communication device between the user and the SACD 20 (and further external devices connected to the SACD 20), where the user information is inputted by the user using the user interface 35 and transmitted to the SACD 20 using the UD communication unit 32. Depending on the application, this might help the user to avoid touching the SACD 20 and the further external devices for entering any such user information and therefore contributes to reducing the risks of infection spreads.

In an embodiment of the invention, the external device can for example be a lift or elevator, and in this case, the user may use the UD 30 to request the elevator services and specify the selected floor. This information is transmitted to the SACD 20 through the wireless communication established between the SACD 20 & UD 30 and subsequently transmitted to the elevator control panel through a connection between the SACD 20 and the elevator. In an embodiment of the invention, the controlled zone 15 is a lift or an elevator and the access control information comprises an elevator service desired such as a floor selection. In an embodiment of the invention, the SACD 20 is connected to the elevator/lift floor electronic circuit or control panel or button/keyboard panel for automatically (and without any touching or further human intervention) controlling the elevator service specified by the user, such as the floor selection.

In an embodiment of the invention, the UD 30 further comprises a power source for supplying power to the electronic components of the device 30. The communication unit 32 comprises a transmitter configured/adapted to send the access control signal to the SACD 20. The communication unit 32 preferably further comprises a receiver for receiving signals from the SACD 20 depending on the application, such as the access control notification signals. The communication unit 32 is connected to the controller for which is configured/adapted to process the received signals and take actions based on the processing. In an embodiment of the invention, the UD 30 further comprises a face shield unit 36 comprising a face shield 168 configured/adapted to cover the face of the user (at least the portal portion of the user's face) for preventing spread of infectious diseases. Preferably, the face shield unit 36 further comprises a face shield operation module 160, a lock/unlock mechanism 162 and a motor 164 in connection with the face shield 168 for automatically controlling the face shield 168 through the controller 34 such as adjusting the face shield 168 from an unsecured position to a secured position. The face shield 168 is made of a suitable material depending on the application. In an embodiment of the invention, the face shield 168 is made of a solid material such as transparent plastic or glass or silicon acting as barrier to droplets and body fluids without obstructing the vision of the user.

Referring to FIGS. 6 to 8, the SACS 10 can be used to control access of users for infection control in connection with various types and typographies of controlled zones 15. The SACS 10 comprising SACDs 20 and UDs 30 can be used to control any geographical or physical zone of any type, including any indoor or outdoor area, depending on the application and needs. The controlled zone 15 can be any outdoor or indoor geographical or physical zone, space, area, room or infrastructure. Preferably, the SACS 10 is being deployed in an indoor environment. Users not wearing UDs 30 (users are not allowed access, whereas users wearing UDs 30 (users 15B) are authorized access to the controlled zone 15. In an embodiment of the invention, the controlled zone 15 is an indoor physical space requiring access control for preventing the spread of infections between individuals while they are within that space. The controlled zone 15 can for example be a geographical/physical location or space representing a high risk of contamination between people, such as an area with frequent crowds and/or narrow spacing between individuals such as an elevator or lift, a store, a conference room, a pass hall in a private company or in a public area such as shopping mall, a school, a playground for kids, a reception area and so on. In an embodiment of the invention, the controlled zone is an area representing a high risk environment for the spread of infectious disease such as a hospital or a medical clinic for example.

In an embodiment of the invention, the controlled zone is a facility hosting people with vulnerable health conditions such as a healthcare facility hosting patients with vulnerable health conditions such elder patients or patients having chronic diseases such as cancer. Since contamination of these patients can lead to very serious health consequences, securing the facilities where these vulnerable patients stay becomes very important. In an embodiment of the invention (as illustrated in FIG. 7), a controlled zone 15 may have an access-controlled entry and an access-controlled exit and in this case, the SACS 10 preferably comprises a SACD 20M at the access-controlled entry and a SACD at the access-controlled exit respectively to control entry and exit to and from the controlled zone and take record of the users entering and exiting the controlled zone 15 based on their user identifiers.

In an embodiment of the invention, the UD 30 monitors the effective use/wear of the UD 30 during the entire journey between the time the user is granted access to the controlled zone 15 at the entry point by the SACD 20M until the time the user requests permission to exit the controlled zone 15 at the exit point by the SACD 20N. In an embodiment of the invention, the UD 30 notifies the SACD 20N at the exit point if the user took off the UD 30 during that journey while he was inside the controlled zone 15. In an embodiment of the invention, the SACD 20 denies granting an exit permission to the user if the record shows that he did not wear the UD 30 (at any point of time, or during a predefined period of time) inside the controlled zone 15 during his journey inside the controlled zone 15. The SACD 20 is configured/adapted to be connected to the relevant authorities (such as the security guards or police or administrator of the controlled zone) to notify of such a breach. This can lead to repercussions such as fine or imprisonment.

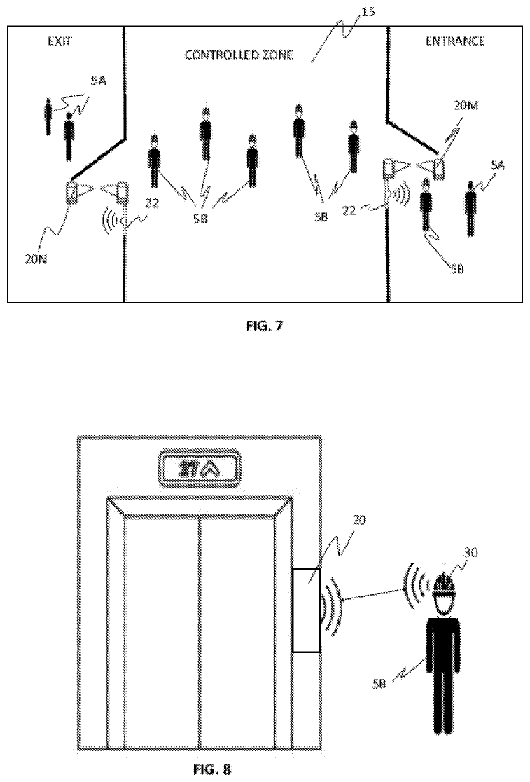

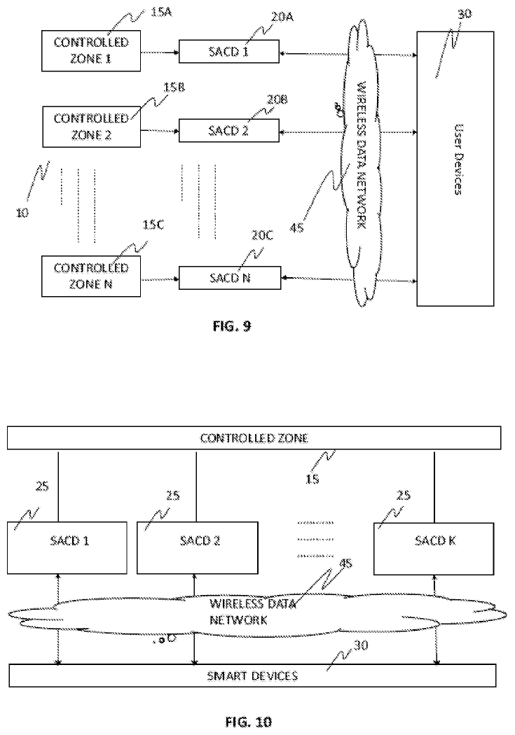

In an embodiment of the invention, the SACD 20 is configured/adapted to control access to a building lift and related building floors (as illustrated in FIG. 8). In an embodiment of the invention, the SACD 20 is connected to the keyboard (or keyboard panel circuit) of the elevator for receiving a user desired floor and automatically sending a floor request to the lift keyboard (or keyboard panel circuit) without any touch by the user. The floor number can be stored inside the UD memory 38 and automatically communicated to the SACD 20 during the authentication/access control process. The floor associated to the user can also be specified by the user at the time of accessing the elevator through the user interface 35. The floor identifier may also be stored inside a memory or database accessible to the SACD 20. The database may store user identifiers with their associated registered/authorized floors. The SACD 20 queries the database using user identifiers to identify their respective pre-stored/authorized floors, and automatically communicate the pre-stored/authorized floors to the elevator controller/keyboard panel. The elevator controller automatically triggers the relevant floor buttons/switches and sends the users to their pre-stored/authorized floors based on the user identifiers without any further action required by the users. This ensures touchless and seamless access to the elevator and floors. The SACD 20 may comprise a connector/converter adapted to convert a floor identifier (such as a floor number) to a signal readable by the elevator controller/keyboard panel or an associated user interface such as a touchless user interface or a voice-based command unit connected to the elevator controller.

Referring to FIG. 9, in an embodiment of the invention, the Smart Access Control System (SACS) 10 is configured/adapted to be deployed in a facility having a plurality of zones to be controlled from infections. In this scenario, each controlled zone (15A, 15B, . . . , 15N) respectively is being equipped with one SACD 20 (20A, 20B, . . . , 20N) configured/adapted to control access of users to the respective controlled zones 15. Referring to FIG. 10, in an embodiment of the invention, the SACS 10 comprises a plurality of SACDs 20 configured/adapted to control access to a single controlled zone 15. This is in case the controlled zone 15 comprises multiple access-controlled entry/exit points where each access-controlled entry/exit point requires a distinct SACD 20.

Referring to FIG. 11, in an embodiment of the invention, there is provided a process of controlling access to a gated/controlled zone for infection control in accordance with an embodiment of the present invention (140) comprising the steps of: the SACD 20 sends access control notification signals (preferably on a continuous and periodic manner) (142), the UD 30 scans for and processes the access control notification signals (144), the UD 30 sends an access authorization request to the SACD with the UD ID (or user ID) only if the UD 30 is worn/used by the user (and/or face shield is being secured depending on the application) and the user is in compliance with any other H&S requirements as determined by the UD 30 (146), the SACS grants access to the user inside the controlled zone in case of successful authentication and compliance with the H&S requirements including wearing the UD 30 (148). The process 140 and related steps can vary according to the various embodiments of the present invention as described herein.

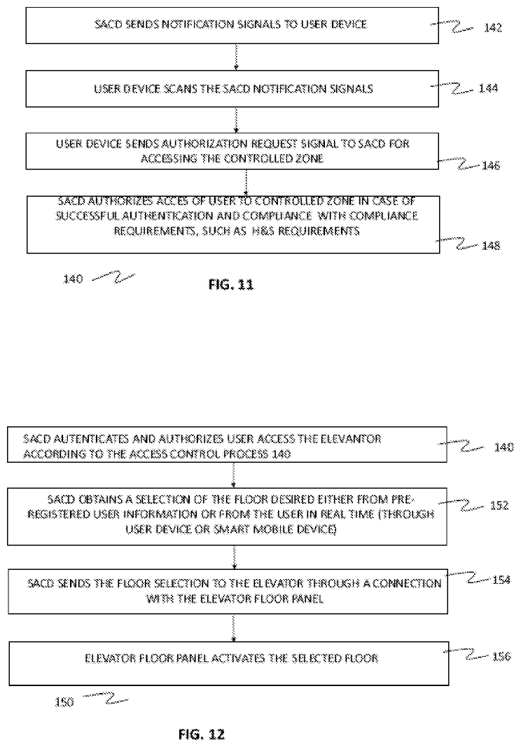

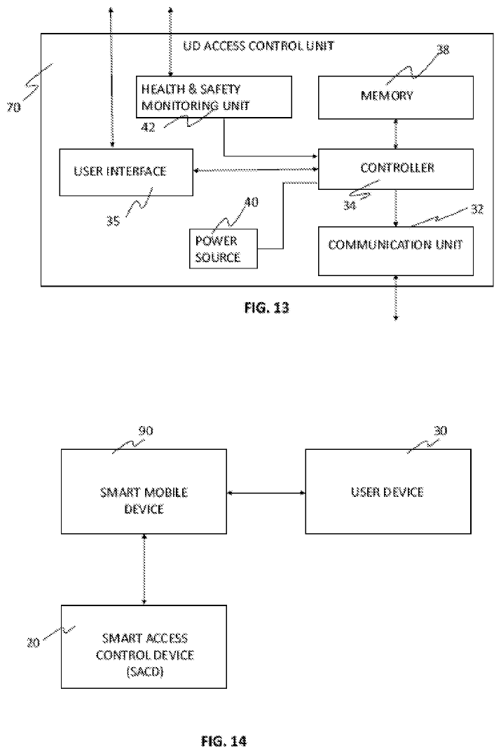

Referring to FIG. 12, in an embodiment of the invention, there is provided a process of controlling access and providing service to an elevator/lift for infection control (150), the process comprising: Step A (140): controlling access to the elevator as per the process set out according to the various embodiments of the invention; Step B (152): obtaining by the SACD 20 a floor selection from either pre-registered data or from the user in real time through his UD 30 or his mobile device; the floor selection can be pre-stored by the SACD 20, by the UD 30 or in the mobile device depending on the application; the pre-registration of the floor is practical for applications where the user is a pre-approved user to a specific floor only (for example he is an employee of a company located at that specific pre-approved floor); otherwise, the floor selection can be provided in real time by the user either using the user interface of his UD 30 (for example a voice command) or through his mobile device when a mobile device is used to conduct at least a part of the actions of the processes 140 & 150 according to the various embodiments of the invention; Step C (154): sending the floor selection by the SACD 20 to the elevator floor panel (keyboard or electronic circuit depending on the application) for obtaining the elevator service to that floor; and Step D (156): the elevator panel activates the selected floor (in case the user has the right to access said floor, if required, after conducting any additional user authentication required). As illustrated in FIG. 13, in an embodiment of the invention, there is provided a Personal Protective Equipment (PPE) Access Control unit 70 (also called Smart Access Control Unit or SACU) comprising at least some of the components of the UD 30 as described herein. Preferably, the PPE Access Control Unit 70 comprises all the electronic components of the UD 30. In an embodiment of the invention, the PPE Access Control unit 70 comprises at least a part of the following: the communication unit 32, the controller 34, the user interface 35, the memory 38, the power source 40, and the Health & Safety monitoring unit 42.

In an embodiment of the invention, PPE Access Control Unit 70 is a standalone component configured/adapted to be mechanically coupled to a Personal Protective Equipment (PPE). The mechanical coupling can take any suitable form such as a magnet based clutch, a magnetic clutch, or any other type of mechanical connection. In an embodiment of the invention, the PPE Access Control Unit 70 is configured/adapted to be removably coupled to a PPE such that it can be coupled and decoupled from the PPE based on the needs and application. The PPE can be a garment, a clothing, a face shield, a helmet or any other type of personal protective equipment. In an embodiment of the invention, the PPE is the UD 30. However, the PPE can be another device which is required to be used by the user for purposes of access control to the controlled zone 15. Such a device can be a device configured/adapted to be worn/used by the user, carried or accompanied by the user in any other way. In an embodiment of the invention, the PPE can be a face protective device such as a face shield, a face mask, a helmet or any other device designed to protect/isolate the user's portal portion of the face for preventing the spread of infectious diseases.

In an embodiment of the invention, the UD 30 is configured/adapted to be connected to an External Communication Device 90, preferably through a wireless data network, using Bluetooth or any other suitable communication technology. The establishment of the wireless communication between the UD 30 and the External Communication Device 90 is preferably conducted through the UD communication unit 32 and a communication unit related to the External Communication Device 90. In an embodiment of the invention, the External Communication Device 90 is a Smart Mobile Device (such as an iPhone), and the UD 30 enables the user to wirelessly connect to his smart mobile device enabling him to communicate with others through the smart mobile device using the UD 30 as an intermediary (proxy) to connect his earphones and other accessories. This is as it may be difficult or impractical for the user to put his smart mobile device on his ears during a phone call while he is wearing the UD 30, and it may be difficult or impractical to insert an earphone cable between his smart mobile device and his ears passing through the UD 30.

Referring to FIG. 14, in an embodiment of the invention, the communication between the UD 30 and the SACD 20 is intermediated through the user's smart mobile device 90 which acts as a mediator device (or proxy) between both devices 20 & 30. In an embodiment of the invention, the UD 30 is configured/adapted to establish a first wireless communication with the user's smart phone device 90, and the smart phone device 90 is configured/adapted to establish a second wireless communication device with the SACD 20, where the first and second wireless communications are configured/adapted to conduct/complete the entire access control/authorization process and requirements in accordance with the various embodiments of the present invention. In an embodiment of the invention, the three devices 20, 30 & 90 are configured/adapted to conduct/complete the entire access control/authorization process and requirements in accordance with the various embodiments of the invention. In an embodiment of the invention, at least a part of the functions and processes conducted by the UD 30 according to the various embodiments of the present invention are conducted by the smart mobile device 90, and at least a part of the components of the UD 30 according to the various embodiments of the present invention are part of the smart mobile device 90. In an embodiment of the invention, at least a part of the functions and processes conducted by the SACD 20 according to the various embodiments of the present invention are conducted by the smart mobile device 90, and at least a part of the components of the SACD 20 according to the various embodiments of the present invention are part of the smart mobile device 90. In an embodiment of the invention, the smart mobile device 90 runs a mobile application configured/adapted to enable the use of the smart mobile device 90 in accordance with the various embodiments of the present invention. In an embodiment of the invention, the mobile application enables the user or third party administrator to set a user account and configure the UD 30 for the user's specific use (for example to register or change the user's identifier).

In an embodiment of the invention, the UD 30 is configured/adapted to be connected to a Smart Device 90 for exchanging information between both devices 30 & 90. The connection between the Smart Device 90 and the UD 30 can be a wired or wireless connection. In an embodiment of the invention, the wireless communication between the UD 30 and the Smart Device 90 is Bluetooth Low Energy (BLE). The Smart Device 90 can be a smart phone device, a smart tablet or any other type of smart device. In an embodiment of the invention, all the processes, components and features associated to the UD 30 according to the various embodiments of the present invention (including the communication processes with the SACD 20) would also apply to the communication with the Smart Device 90 by making any suitable adjustments required depending on the application.

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follow.

1. A user device (UD) configured/adapted to be used by a user for safety or infection control, wherein the user device comprises a smart access control unit (SACU) comprising a communication unit configured/adapted to be in wireless communication with a smart access control device (SACD) for controlling access of the user to a controlled zone based on said wireless communication.

2. The user device of claim 1, wherein the SACD grants access to the user in response to an access authorization request received from the SACU.

3. The user device of claim 2, wherein the SACU is configured/adapted to send the access authorization request to the SACD automatically and without human intervention in response to an access control notification signal received from the SACD when the user is within an access control area associated to the controlled zone.

4. The user device of claim 3, wherein the SACU is configured/adapted to first determine compliance of the user with compliance requirements, such as Health & Safety (H&S) requirements as a condition to sending the access authorization request to the SACD.

5. The user device of claim 4, wherein the SACU further comprises a PPE use detector to detect a proper use of the personal protective equipment by the user, and the H&S requirements comprise the user is properly using the personal protective equipment.

6. The user device of claim 5, wherein PPE use detector determines whether the user is wearing/using the PPE or, in case the PPE is a smart face protective device having an adjustable face shield, whether the face shield is being secured.

7. The user device of claim 4, wherein the SACU further comprises a thermal detector for detecting a body temperature of the user, and the H&S requirements further comprise the user's body temperature is below a predefined temperature threshold.

8. The user device of claim 7, wherein the predefined temperature threshold is 38 degrees Celsius.

9. The user device of claim 1, wherein the SACD is configured/adapted to authenticate the user prior to granting access to the controlled zone, wherein the authentication comprises determining if the user is a pre-approved user based on a user identifier obtained from the user device and a pre-stored list of approved users accessible to the SACD.

10. The user device of claim 1, wherein the controlled zone is an elevator.

11. The user device of claim 10, wherein the elevator has a floor panel and wherein the SACD is connected to the elevator floor panel for providing a floor selection of the user to be serviced by the elevator.

12. The user device of claim 11, wherein the floor selection is obtained by the SACD from the SACU.

13. The user device of claim 12, wherein the floor selection is a pre-authorized floor stored in a database accessible to the SACD.

14. The user device of claim 1, wherein the wireless communication between the SACU and the SACD is either a direct or indirect communication through a proxy device.

15. The user device as claimed in claim 14, wherein the proxy device is a user's smart mobile device running a mobile application configured/adapted to process at least a part of the actions required for the purpose of access control to the controlled zone.

16. The user device of claim 1, wherein the wireless communication is selected from the group consisting of Near Field Communication (NFC) and Bluetooth Low Energy (BLE).

17. The user device of claim 1, wherein the SACU is removably coupled or permanently integrated to a wearable, portable or movable user device.

18. The user device of claim 1, wherein the wearable, portable, or movable user device comprises at least one of:
an accessory such as a bracelet, a ring, a watch, a pen, a key holder;
an official document such as a passport, an identity card, a smart card, a smart document; and
a protective equipment such as a protective clothing, a helmet, a face shield, a garment or an equipment designed to protect the user from communicating or contracting infectious diseases, such as COVID-19.

19. The user device of claim 1, wherein the user device is a smart face protective device configured/adapted to be worn/used by the user for covering the user's portal portion of the face, and to be used by the user for infection control against infectious diseases such as COVID-19.

20. (canceled)

21. A smart access control unit (SACU) configured/adapted to be used in connection with a user device, the SACU comprising a communication unit configured/adapted to be in wireless communication with a smart access control device (SACD) for controlling access of the user to a controlled zone based on said wireless communication.

22-26. (canceled)
